(19) United States
(12) Patent Application Publication
(10) Pub. No.: US 2025/0286452 A1
(43) Pub. Date: Sep. 11, 2025

(54) DC-DC CONVERTER CIRCUIT AND CORRESPONDING METHOD OF OPERATION

(71) Applicant: STMicroelectronics S.r.l., Agrate Brianza (MB) (IT)

(72) Inventors: Alessandro BERTOLINI, Vermiglio (IT); Alessandro GASPARINI, Cusano Milanino (IT); Paolo MELILLO, Caltanissetta (CL) (IT); Salvatore LEVANTINO, Milano (IT); Massimo GHIONI, Monza (MB) (IT)

(73) Assignee: STMicroelectronics S.r.l., Agrate Brianza (MB) (IT)

(21) Appl. No.: 19/211,969

(22) Filed: May 19, 2025

Related U.S. Application Data
(63) Continuation of application No. 18/132,774, filed on Apr. 10, 2023, now Pat. No. 12,334,817.

(30) Foreign Application Priority Data
Apr. 15, 2022 (IT) 102022000007685

(51) Int. Cl. H02M 3/07; H02M 1/00; H02M 3/158

(52) U.S. Cl. CPC H02M 3/07; H02M 1/0003; H02M 1/0095; H02M 1/0025; H02M 3/158

(57) ABSTRACT

In a multi-level hybrid DC-DC converter with a flying capacitor, a feedback circuit includes a first oscillator and produces a first clock signal with a frequency dependent on an output voltage. A second oscillator produces a second clock signal having a frequency dependent on a reference voltage. A logic circuit switches, as a function of the first and second clock signals, connection of the flying capacitor between one state where the flying capacitor is connected between an input node and a switching node, and another state where the capacitor is connected between the switching node and a ground node. The duty cycle of the first/second clock signal varies so that when the flying capacitor voltage is lower than a target voltage a duration of the one state is increased, and when the flying capacitor voltage is higher than the target voltage a duration of the another state is increased.

### CROSS-REFERENCE TO RELATED APPLICATIONS

This application is a continuation of U.S. patent application Ser. No. 18/132,774, filed Apr. 10, 2023, which claims the priority benefit of Italian Application for Patent No. 102022000007685 filed on Apr. 15, 2022, the contents of which are hereby incorporated by reference in their entireties to the maximum extent allowable by law.

### TECHNICAL FIELD

The description relates to time-based switched capacitor (SC) or hybrid DC-DC converters.

### BACKGROUND

Throughout this description, various documents will be referred to by reproducing between square brackets (e.g., [X]) a number identifying a document in a list of reference documents that appears at the end of the detailed description. Each of these reference documents is incorporated herein by reference.

Time-based control techniques for electronic converters rely on the information inferable from the time shift (or delay) between time events in one or more control signals for controlling operation of the converter. For instance, such time events may be the edges of one or more digital (e.g., binary) signals, such as the rising edges, the falling edges, or both. The advantages of time-based control techniques, compared to conventional voltage-based control techniques, include a reduced silicon area occupation and a lower power consumption of the control circuitry. Such advantages become more relevant as the converter switching frequency increases and/or the technology node scales down. In particular, with regard to the switching frequency, the higher the converter switching frequency, the higher the control loop bandwidth, and so the larger the gain-bandwidth product (GBWP) of an analog error amplifier contained in the controller has to be in the case of a conventional voltage-based control architecture. A large bandwidth implies complex design and large power consumption of the voltage-based controller. With regard to the technology node scaling, analog signals are limited by the scaled (e.g., lowered) power supply and by the design complexity, while CMOS signals (e.g., signals switching between the positive supply rail V_{DD} and the reference or ground supply rail V_{GND}) take advantage of the technology shrinking.

In this context, documents [1], [2] and [3] disclose high-frequency CMOS buck converters including a time-based controller.

FIG. 1 is a circuit diagram exemplary of a conventional buck converter 10. The buck converter 10 includes a half-bridge switching circuit arranged between an input node 100 configured to receive an input voltage Vᵢₙ and a ground node 102 configured to provide a ground voltage V_{gnd} (e.g., 0 V). The half-bridge circuit includes a high-side switch HS arranged between the input node 100 and a switching node 104 where a voltage V_{X} is produced, and a low-side switch LS arranged between the switching node 104 and the ground node 102. Switches HS and LS may include (e.g., consist of) transistors (e.g., power transistors) such as a metal-oxide-semiconductor (MOS) transistors, optionally n-channel MOS transistors. The buck converter 10 is configured for coupling to an inductor L (e.g., an external inductor) having a first terminal coupled to the switching node 104 and a second terminal coupled to an output node 106 where an output voltage Vₒᵤₜ is produced. A capacitor C_{O} (e.g., an external capacitor) may be coupled between the output node 106 and the ground node 102 to operate the converter 10 (e.g., to stabilize the output voltage Vₒᵤₜ).

A conventional buck converter 10 as exemplified in FIG. 1 may have two main limitations in the case of large conversion ratios. In particular, for high values of the input voltage Vᵢₙ, the power switches HS and LS have to be high-voltage rated, and typically high-voltage rated MOS transistors are less conductive and larger than low-voltage rated MOS transistors. Additionally, large values of the input voltage Vᵢₙ and low values of the output voltage Vₒᵤₜ imply high voltage drops on the inductor L, which may result in large current ripples in the inductor L, and thus also produce large output voltage ripples.

A known circuit arrangement that may be used to mitigate the above-mentioned limitations of conventional converters is exemplified in FIG. 2, which is a circuit diagram exemplary of a three-level (in short, 3L) hybrid buck converter 20. Conventionally, the wording “three-level” converter refers to a switched capacitor converter (e.g., including four power transistors and a flying capacitor) where the switching node can switch between three different voltage levels (e.g., Vᵢₙ, Vᵢₙ/2, and V_{gnd}), and the wording “hybrid converter” refers to a switched capacitor converter operating with an inductor, which allows regulating the output voltage Vₒᵤₜ (while conventional switched capacitor converters have a fixed conversion ratio).

As exemplified in FIG. 2, the three-level hybrid buck converter 20 includes a four-switch switching circuit arranged between an input node 200 configured to receive an input voltage Vᵢₙ and a ground node 202 configured to provide a ground voltage V_{gnd} (e.g., 0 V). The switching circuit includes a first high-side switch M1 arranged between the input node 200 and a high-side intermediate node 203, a second high-side switch M2 arranged between the high-side intermediate node 203 and a switching node 204 where a voltage V_{X} is produced, a first low-side switch M3 arranged between the switching node 204 and a low-side intermediate node 205, and a second low-side switch M4 arranged between the low-side intermediate node 205 and the ground node 202. Switches M1, M2, M3 and M4 may include (e.g., consist of) transistors such as a MOS (power) transistors, optionally n-channel MOS transistors. The buck converter 20 further includes a capacitor C_{f} (which can be an integrated capacitor or an external capacitor, e.g., depending on the converter size and/or speed and thus on the application), also referred to as flying capacitor, arranged between the intermediate high-side node 203 and the intermediate low-side node 205. The voltage drop across capacitor C_{f} (i.e., between nodes 203 and 205) is indicated herein as V_{f}. The buck converter 20 is configured to be coupled to an inductor L (e.g., an external inductor) having a first terminal coupled to the switching node 204 and a second terminal coupled to an output node 206 where an output voltage Vₒᵤₜ is produced. A capacitor C_{O} (e.g., an external capacitor) may be coupled between the output node 206 and the ground node 202 to operate the converter 20 (e.g., to stabilize the output voltage Vₒᵤₜ).

The operation principle of a three-level buck converter 20 is explained with reference to FIGS. 3A to 3D, which are circuit diagrams exemplary of different operation phases of a buck converter 20 operating at steady-state. In particular, greyed-out components illustrated in FIGS. 3A to 3D are intended to indicate the switches that are not conductive (e.g., off) during each operation phase.

As exemplified in FIG. 3A, during a first operation phase of converter 20 (phase ϕ1 having duration T_{ϕ1}), switches M1 and M3 are closed (e.g., conductive, on) and switches M2 and M4 are open (e.g., non-conductive, off). A current flows from the input node 200 to the output node 206 through switch M1, node 203, capacitor C_{f}, node 205, switch M3, node 204, inductor L. During the first phase, the voltage V_{X} at the switching node 204 is equal to V_{X}=Vᵢₙ−V_{f}=Vᵢₙ/2. During the first phase, capacitor C_{f} is thus coupled between the input node 200 and the switching node 204 (i.e., the inductor L), and it gets charged.

As exemplified in FIG. 3B, during a second operation phase of converter 20 (phase ϕ2 having duration T_{ϕ2}), switches M3 and M4 are closed and switches M1 and M2 are open. A current flows from the ground node 202 to the output node 206 through switch M4, node 205, switch M3, node 204, inductor L. During the second phase, the voltage V_{X} at the switching node 204 is equal to V_{X}=V_{gnd}=0 V.

As exemplified in FIG. 3C, during a third operation phase of converter 20 (phase ϕ3 having duration T_{ϕ3}), switches M2 and M4 are closed and switches M1 and M3 are open. A current flows from the ground node 202 to the output node 206 through switch M4, node 205, capacitor C_{f}, node 203, switch M2, node 204, inductor L. During the third phase, the voltage V_{X} at the switching node 204 is equal to V_{X}=V_{f}=Vᵢₙ/2. During the third phase, capacitor C_{f} is thus coupled between the switching node 204 (i.e., the inductor L) and the ground node 202, and it gets discharged.

As exemplified in FIG. 3D, during a fourth operation phase of converter 20 (phase ϕ4 having duration T_{ϕ4}), switches M3 and M4 are closed and switches M1 and M2 are open. A current flows from the ground node 202 to the output node 206 through switch M4, node 205, switch M3, node 204, inductor L. During the fourth phase, the voltage V_{X} at the switching node 204 is equal to V_{X}=V_{gnd}=0 V.

Therefore, the conversion ratio Vₒᵤₜ/Vᵢₙ of converter 20 operating according to the four-phase operation scheme described with reference to FIGS. 3A to 3D can be computed as:

$$\frac{{V}_{out}}{{V}_{in}} = \frac{{T}_{ϕ 1} + {T}_{ϕ 3}}{2 \cdot {T}_{SW}}$$

where T_{ϕ1} is the duration of the first phase ϕ1, T_{ϕ3} is the duration of the third phase ϕ3, and T_{SW} is the duration of a switching cycle (e.g., T_{SW}=T_{ϕ1}+T_{ϕ2}+T_{ϕ3}+T_{ϕ4}).

The operation scheme exemplified in FIGS. 3A to 3D allows the output voltage Vₒᵤₜ to vary between V_{gnd} and Vᵢₙ/2 (i.e., it allows a conversion ratio between 0 and 0.5, limiting the maximum output voltage Vₒᵤₜ to Vᵢₙ/2). Alternatively, the second phase and the fourth phase (exemplified in FIGS. 3B and 3D, respectively) may be modified by connecting the switching node 204 to the input node 200 (at voltage Vᵢₙ) instead of connecting it to the ground node 202 (at voltage V_{gnd}=0 V). In other terms, during the second modified phase and the fourth modified phase the switches M1 and M2 may be closed and the switches M3 and M4 may be open, so that a current would flow from the input node 200 to the output node 206 through switch M1, node 203, switch M2, node 204, inductor L. During the second and fourth modified phases, the voltage V_{X} at the switching node 204 would thus be equal to V_{X}=Vᵢₙ. As a result, the “modified” operation scheme allows the output voltage Vₒᵤₜ to vary between Vᵢₙ/2 and Vᵢₙ (i.e., it allows a conversion ratio between 0.5 and 1, limiting the minimum output voltage Vₒᵤₜ to Vᵢₙ/2).

As anticipated, a three-level hybrid (buck) converter 20 as exemplified in FIG. 2 may mitigate the above-mentioned limitations of conventional (buck) converters. In particular, capacitor C_{f} maintains a constant voltage V_{f}=Vᵢₙ/2 across its plates, reducing the voltage stress on the power MOS transistors M1, M2, M3, M4 and thus facilitating reducing the overall silicon area occupation and the switching losses (e.g., allowing the implementation of smaller MOS transistors M1, M2, M3, M4). Additionally, the maximum voltage across the inductor L is limited to Vᵢₙ/2−Vₒᵤₜ, reducing current and voltage ripples. Document [4] provides a detailed analysis and comparison between conventional and three-level buck converters.

In a three-level buck converter 20 as exemplified in FIGS. 2 and 3A to 3D, precise voltage conversion with low voltage ripples and low losses may be sought by keeping the voltage V_{f} across capacitor C_{f} constant to a value as close as possible to Vᵢₙ/2. As discussed with reference to FIGS. 3A to 3D, if the intervals T_{ϕ1} and T_{ϕ3} are equal, capacitor C_{f} is charged and discharged by the same amount of charge. However, mismatches in the driving signals of switches M1, M2, M3 and M4, and/or bottom plate parasitic capacitance effects may produce a difference in the charge sourced to capacitor C_{f} during the first operation phase (FIG. 3A) and the charge sunk from capacitor C_{f} during the third operation phase (FIG. 3C). An unbalanced voltage on capacitor C_{f} resulting from such non-idealities could result in voltage overstress on the power transistors M1, M2, M3, M4.

In view of the known solutions discussed above, there is a need in the art to provide three-level hybrid DC-DC switching converters including improved time-based controller circuits that facilitate balancing of the flying capacitor voltage.

### SUMMARY

An object of one or more embodiments is to contribute in providing such improved DC-DC switching converters.

According to one or more embodiments, such an object can be achieved by a circuit having the features set forth in the claims that follow.

One or more embodiments may relate to a corresponding method of operating a DC-DC switching converter.

The claims are an integral part of the technical teaching provided herein in respect of the embodiments.

In one or more embodiments, a DC-DC converter circuit includes a switching stage arranged between an input node configured to receive an input voltage and a ground node configured to provide a ground voltage. The switching stage includes a switching node selectively couplable to the input node or to the ground node. The switching node is configured to be coupled to an inductor for producing an output voltage at an output node of the DC-DC converter circuit. The switching stage also includes a capacitor having a first terminal selectively couplable to the input node or to the switching node and a second terminal selectively couplable to the switching node or to the ground node. The converter circuit includes a time-based feedback circuit including a first voltage-controlled oscillator (e.g., a feedback VCO). The time-based feedback circuit is configured to produce a first clock signal having a respective frequency that is a function of the converter output voltage. The converter circuit includes a second voltage-controlled oscillator (e.g., a reference VCO) configured to produce a second clock signal having a respective frequency that is a function of a reference voltage. The converter circuit includes a logic circuit configured to receive the first clock signal and the second clock signal and to produce, as a function thereof, one or more control signals for switching operation of the switching stage between first, second, third and fourth operating phases. In the first operating phase the capacitor is connected between the input node and the switching node. In the second operating phase the capacitor has one floating terminal and the switching node is connected either to the input node or to the ground node. In the third operating phase the capacitor is connected between the switching node and the ground node. In the fourth operating phase the capacitor has one floating terminal and the switching node is connected either to the input node or to the ground node. The converter circuit also includes a voltage balancing circuit configured to sense a voltage across the capacitor, compare the sensed voltage to a target voltage, and produce a balancing signal indicative of the difference between the sensed voltage and the target voltage. At least one of the first voltage-controlled oscillator and the second voltage-controlled oscillator is configured to receive the balancing signal and to vary the duty-cycle of the respective produced clock signal as a function thereof. If the balancing signal is indicative of the sensed voltage being lower than the target voltage, the duration of the first operating phase is increased, and if the balancing signal is indicative of the sensed voltage being higher than the target voltage, the duration of the third operating phase is increased.

One or more embodiments may thus facilitate balancing the voltage across the flying capacitor of a hybrid, switched capacitor DC-DC converter that includes a time-based control architecture.

In one or more embodiments, the switching stage includes a first high-side switch arranged between the input node and a high-side intermediate node, a second high-side switch arranged between the high-side intermediate node and the switching node, a first low-side switch arranged between the switching node and a low-side intermediate node, and a second low-side switch arranged between the low-side intermediate node and the ground node. The capacitor is arranged between the high-side intermediate node and the low-side intermediate node.

In one or more embodiments, the DC-DC converter circuit includes a voltage divider circuit coupled to the output node to receive the output voltage and produce a feedback voltage as a function thereof (e.g., proportionally to the output voltage), and the first voltage-controlled oscillator is configured to produce the first clock signal having a respective frequency that is a function of the feedback voltage.

In one or more embodiments, the first voltage-controlled oscillator is configured to produce an intermediate clock signal having a respective frequency that is a function of the output voltage, and the time-based feedback circuit further includes a first delay element and a second delay element configured to delay the intermediate clock signal as a function of a first signal indicative of the output voltage and a second signal indicative of the time derivative of the output voltage, respectively, to produce the first clock signal.

In one or more embodiments, the logic circuit is configured to produce the one or more control signals so that the switching stage switches to the first operating phase in response to a rising edge detected in the second clock signal, to the second operating phase in response to a rising edge detected in the first clock signal, to the third operating phase in response to a falling edge detected in the second clock signal, and to the fourth operating phase in response to a falling edge detected in the first clock signal.

In one or more embodiments, the logic circuit is configured to produce the one or more control signals so that the switching stage switches to the first operating phase in response to the first clock signal being de-asserted and the second clock signal being asserted, to the second operating phase in response to the first clock signal being asserted and the second clock signal being asserted, to the third operating phase in response to the first clock signal being asserted and the second clock signal being de-asserted, and to the fourth operating phase in response to the first clock signal being de-asserted and the second clock signal being de-asserted.

In one or more embodiments, the target voltage is equal to half of the input voltage.

In one or more embodiments, the voltage balancing circuit includes a transconductance amplifier circuit having a first input configured to receive the voltage sensed across the capacitor and a second input configured to receive the target voltage, and a further capacitor having a first terminal coupled to the output of the transconductance amplifier to be charged and discharged thereby. The balancing signal is produced at the first terminal of the further capacitor.

In one or more embodiments, the first voltage-controlled oscillator and/or the second voltage-controlled oscillator includes an oscillator circuit configured to produce an oscillating signal having a respective frequency that is a function of the output voltage and/or the reference voltage, respectively. The first voltage-controlled oscillator and/or the second voltage-controlled oscillator includes a delay circuit configured to produce a delayed replica of the oscillating signal, wherein the amount of delay of the delayed replica is a function of the balancing signal. The first voltage-controlled oscillator and/or the second voltage-controlled oscillator includes a logic circuit configured to assert the respective produced clock signal in response to an edge detected (e.g., rising or falling) in the oscillating signal, and de-assert the respective produced clock signal in response to a corresponding edge (e.g., rising or falling, respectively) detected in the delayed replica of the oscillating signal.

In one or more embodiments, a method of operating a DC-DC converter circuit includes:
providing an input voltage to the input node of the DC-DC converter circuit;
producing a first clock signal having a respective frequency that is a function of the output voltage of the DC-DC converter circuit;
producing a second clock signal having a respective frequency that is a function of a reference voltage;
switching operation of the switching stage of the DC-DC converter circuit, as a function of the first clock signal and the second clock signal, between a first operating phase wherein the capacitor is connected between the input node and the switching node, a second operating phase wherein the capacitor has one floating terminal and the switching node is connected either to the input node or to the ground node, a third operating phase wherein the capacitor is connected between the switching node and the ground node, and a fourth operating phase wherein the capacitor has one floating terminal and the switching node is connected either to the input node or to the ground node;
sensing a voltage across the capacitor of the DC-DC converter circuit, comparing the sensed voltage to a target voltage, and producing a balancing signal indicative of the difference between the sensed voltage and the target voltage; and
varying the duty-cycle of at least one of the first clock signal and the second clock signal as a function of the balancing signal, so that if the balancing signal is indicative of the sensed voltage being lower than the target voltage the duration of the first operating phase is increased, and if the balancing signal is indicative of the sensed voltage being higher than the target voltage the duration of the third operating phase is increased.

In an embodiment, a control circuit for a DC-DC converter comprises: a feedback circuit configured to generate a feedback voltage dependent on an output voltage of the DC-DC converter; a first voltage controlled oscillator configured to generate a first clock signal having a frequency dependent on the feedback voltage; a first programmable delay line configured to delay the first clock signal and output a second clock signal with a delay relative to the first clock signal set as a function of the feedback voltage and a derivative of the feedback voltage; and a phase detector circuit configured to generate pulse width modulation control signals for controlling switching operation of the DC-DC converter, said pulse width modulation control signals generated in response to a detected a phase difference between the second clock signal and a third clock signal.

In an embodiment, a control circuit for a DC-DC converter comprises: a feedback circuit configured to generate a feedback voltage dependent on an output voltage of the DC-DC converter; a first voltage controlled oscillator configured to generate a first clock signal having a frequency dependent on the feedback voltage; a first programmable delay line configured to delay the first clock signal and output a second clock signal with a delay relative to the first clock signal set as a function of a duty cycle control signal; a flip-flop circuit having a data input configured to receive the first clock signal and a clock input configured to receive the second clock signal, wherein an output of the flip-flop circuit generates a third clock signal with a duty cycle adjusted in response to the duty cycle control signal; and a phase detector circuit configured to generate pulse width modulation control signals for controlling switching operation of the DC-DC converter, said pulse width modulation control signals generated in response to a detected a phase difference between the third clock signal and a fourth clock signal.

### BRIEF DESCRIPTION OF THE DRAWINGS

One or more embodiments will now be described, by way of example only, with reference to the annexed figures, wherein:

FIG. 1, previously presented, is a circuit diagram exemplary of a conventional buck converter;

FIG. 2, previously presented, is a circuit diagram exemplary of a three-level hybrid buck converter;

FIGS. 3A to 3D, previously presented, are circuit diagrams exemplary of different operation phases of a three-level hybrid buck converter operating at steady-state;

FIG. 4 is a circuit diagram exemplary of a three-level hybrid buck converter including a time-based controller circuit;

FIG. 5 is a time diagram exemplary of possible time evolution of signals in the converter of FIG. 4;

FIG. 6 is a circuit diagram exemplary of a three-level hybrid buck converter including a time-based controller circuit according to one or more embodiments of the present description;

FIG. 7 is a time diagram exemplary of possible time evolution of signals in the converter of FIG. 6; and

FIG. 8 is a circuit block diagram exemplary of possible implementation details of a voltage-controlled oscillator for use in one or more embodiments.

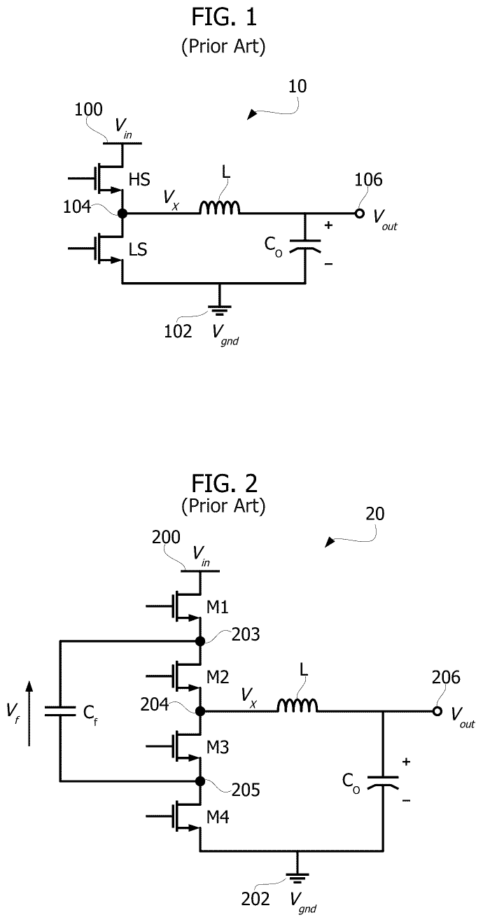

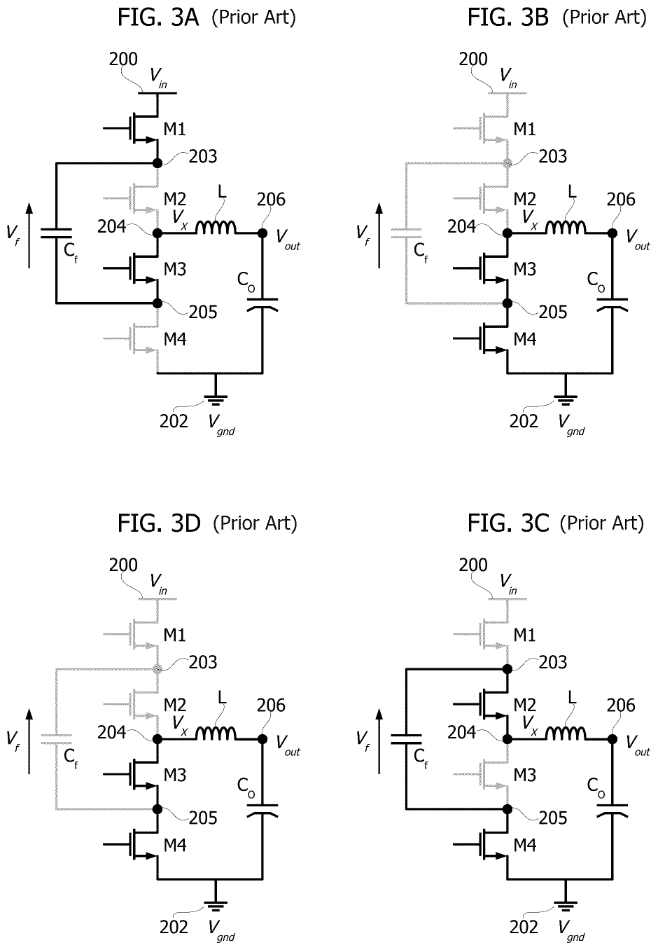

### DETAILED DESCRIPTION

In the ensuing description, one or more specific details are illustrated, aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is included in at least one embodiment. Hence, phrases such as “in an embodiment” or “in one embodiment” that may be present in one or more points of the present description do not necessarily refer to one and the same embodiment. Moreover, particular configurations, structures, or characteristics may be combined in any adequate way in one or more embodiments.

The headings/references used herein are provided merely for convenience and hence do not define the extent of protection or the scope of the embodiments.

Throughout the figures annexed herein, unless the context indicates otherwise, like parts or elements are indicated with like references/numerals and a corresponding description will not be repeated for the sake of brevity.

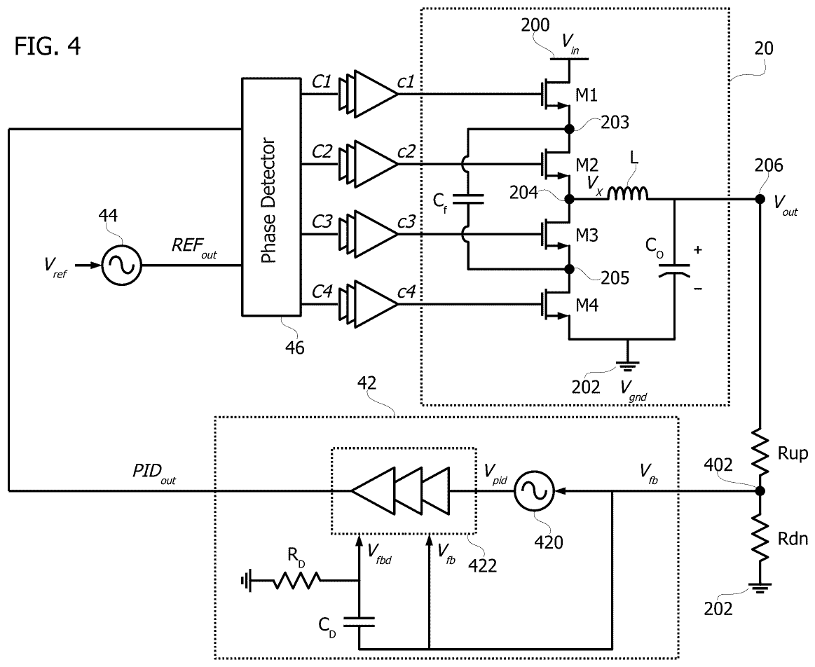

By way of introduction to the detailed description of one or more exemplary embodiments, reference may be first made to FIG. 4, which is a circuit block diagram exemplary of a three-level hybrid buck converter 20 and related time-based control circuitry. A similar time-based control architecture is known, e.g., from United States Patent Publication No. 2021/0384830 A1 (incorporated here by reference).

As exemplified in FIG. 4, the control circuitry of converter 20 includes a voltage divider circuit (e.g., a resistive ladder) coupled to the output node 206 of converter 20 and configured to produce a feedback (voltage) signal V_{fb} indicative of (e.g., proportional to) the output voltage Vₒᵤₜ. For instance, the voltage divider circuit may include a first resistor Rup and a second resistor Rdn coupled in series between node 206 and ground node 202, where the feedback signal V_{fb} is produced at a node 402 intermediate the resistors Rup and Rdn. The control circuitry also includes a PWM signal generation circuit configured to generate one or more PWM signals C1, C2, C3, C4 as a function of the feedback signal V_{fb} and a reference voltage V_{ref}. The control circuitry also includes one or more driver circuits configured to drive a (buck) switching stage 20 as a function of the PWM signal(s) C1, C2, C3, C4, e.g., producing respective drive signals c1, c2, c3, c4.

As exemplified in FIG. 4, the PWM signal generation circuit relies on a time-based proportional-integral-derivative (PID) controller circuit 42 coupled to node 402 to receive the feedback signal V_{fb} and configured to produce a first converter control signal PIDₒᵤₜ as a function thereof.

In particular, the time-based PID controller 42 may include a feedback voltage-controlled oscillator (FVCO) 420 configured to receive the feedback voltage signal V_{fb} and generate a first clock signal V_{pid} as a function of the feedback signal V_{fb}, e.g., having a frequency that is a function of the value of signal V_{fb}. The time-based PID controller 42 may further include an analog differentiator (e.g., a derivative filter circuit) configured to generate a signal V_{fbd} indicative of (e.g., proportional to) the derivative of the feedback signal V_{fb}. In particular, the analog differentiator may include a capacitor C_{D} having a first terminal coupled to node 402 to receive the feedback signal V_{fb} and a second terminal coupled to a first terminal of a resistor R_{D}. The resistor R_{D} may have a second terminal coupled to ground node 202. Therefore, signal V_{fbd} indicative of the derivative of the feedback signal V_{fb} is produced at the node intermediate capacitor C_{D} and resistor R_{D}. The time-based PID controller 42 may further include a feedback voltage-controlled delay line 422 configured to receive the first clock signal V_{pid} and produce a delayed first clock signal PIDₒᵤₜ as a function thereof. In particular, the delay line 422 may include a first delay element having a delay as a function of the feedback signal V_{fb} and a second delay element having a delay as a function of signal V_{fbd}. The first and second delay elements are connected in cascade and generate the delayed first clock signal PIDₒᵤₜ. Delay lines having a programmable delay as a function of a voltage or current signal are well known in the art. For example, U.S. Pat. Nos. 5,650,739 A or 7,696,799 B2 (incorporated by reference) may be cited in this context.

As exemplified in FIG. 4, the PWM signal generation circuit of converter 20 further includes a reference voltage-controlled oscillator (RVCO) 44 configured to receive a reference voltage V_{ref} and produce a second clock signal REFₒᵤₜ (e.g., a reference oscillating signal) having a frequency that is a function of the value of the reference signal V_{ref} (e.g., a period T_{VCO}).

As exemplified in FIG. 4, the PWM signal generation circuit of converter 20 further includes a phase detector circuit 46 (e.g., implemented as an asynchronous finite state machine, AFSM) configured to receive the first delayed clock signal PIDₒᵤₜ and the second clock signal REFₒᵤₜ and to produce the PWM signal(s) C1, C2, C3, C4 as a function thereof. In particular, the values of the PWM signal(s) C1, C2, C3, C4 can be determined as a function of the phase difference Φ (or phase shift) between the clock signals PIDₒᵤₜ and REFₒᵤₜ.

In the embodiment considered, the reference voltage-controlled oscillator 44 thus provides a reference clock signal REFₒᵤₜ having a given (fixed or settable) frequency as a function of the reference voltage V_{ref}. Conversely, the feedback voltage-controlled oscillator 420 varies the frequency of the first clock signal V_{pid} until the feedback signal V_{fb} corresponds to the reference voltage V_{ref}, and in this steady condition the frequency of the first clock signal V_{pid} corresponds to the frequency of the second (reference) clock signal REFₒᵤₜ, but the clock signals are phase shifted by a given phase Φ_{I}. The first oscillator 420 thus implements a regulator with I (integral) component of the phase Φ_{I}. Conversely, the first delay element and the second delay element in the delay line 422 introduce an additional phase Φ_{P} proportional to the feedback signal V_{fb} and an additional phase Φ_{D} proportional to the derivative V_{fbd} of the feedback signal V_{fb}, i.e., the total phase shift Φ corresponds to Φ=Φ_{I}+Φ_{P}+Φ_{D}. The phase shift Φ is detected by the phase detector circuit 46 and used to determine the values of the PWM signals C1, C2, C3, C4 for driving the switching stage 20. Therefore, the ON-times (and/or the duty-cycle values) of signals C1, C2, C3, C4 are varied via a time-based control (with PID regulation) of the phase shift Φ as a function of the feedback signal V_{fb} and the reference voltage V_{ref}. Accordingly, the phase detector 46 may also perform other operations, such as a down-scaling operation of the frequency of the clock signals V_{pid} and/or REFₒᵤₜ, and it is only relevant that the phase detector 46 is configured to generate PWM signals C1, C2, C3, C4 wherein the switch-on duration (or the duty-cycle) of these signals is determined as a function of the phase shift Φ between signals PIDₒᵤₜ and REFₒᵤₜ.

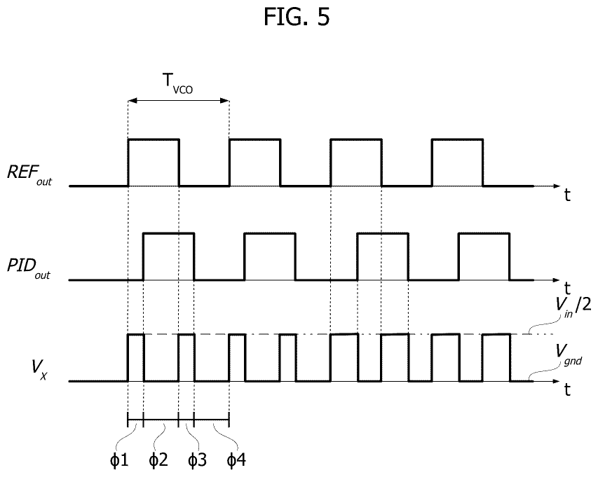

Operation of the control circuitry of converter 20 may be further understood with reference to FIG. 5, which is a time diagram exemplary of possible time evolution of signals REFₒᵤₜ, PIDₒᵤₜ and V_{X} in the converter of FIG. 4. For instance, the phase detector (e.g., finite state machine) 46 may be edge-triggered and may thus detect both rising and falling edges of signals REFₒᵤₜ and PIDₒᵤₜ (e.g., each having a 50% duty-cycle) to produce the PWM signals C1, C2, C3, C4 so that the three-level buck converter 20 operates two phases for each semi-period of the reference clock signal REFₒᵤₜ. In particular, the finite state machine 46 may set the converter 20 to operate in the first phase (ϕ1) in response to a rising edge detected in signal REFₒᵤₜ, in the second phase (ϕ2) in response to a rising edge detected in signal PIDₒᵤₜ, in the third phase (ϕ3) in response to a falling edge detected in signal REF out, and in the fourth phase (ϕ4) in response to a falling edge detected in signal PIDₒᵤₜ, with voltage V_{X} at node 204 switching accordingly between Vᵢₙ/2 and V_{gnd} (e.g., 0 V) or Vᵢₙ. Additionally or alternatively, the phase detector 46 may be level-triggered and may thus detect the levels of both signals REFₒᵤₜ and PIDₒᵤₜ to produce the PWM signals C1, C2, C3, C4 so that the three-level buck converter 20 operates two phases for each semi-period of the reference clock signal REFₒᵤₜ. In particular, the finite state machine 46 may set the converter 20 to operate in the first phase (ϕ1) in response to signal REFₒᵤₜ being asserted and signal PIDₒᵤₜ being de-asserted, in the second phase (ϕ2) in response to signal REFₒᵤₜ being asserted and signal PIDₒᵤₜ being asserted, in the third phase (ϕ3) in response to signal REFₒᵤₜ being de-asserted and signal PIDₒᵤₜ being asserted, and in the fourth phase (ϕ4) in response to signal REFₒᵤₜ being de-asserted and signal PIDₒᵤₜ being de-asserted, with voltage V_{X} at node 204 switching accordingly between Vᵢₙ/2 and V_{gnd} (e.g., 0 V) or Vᵢₙ.

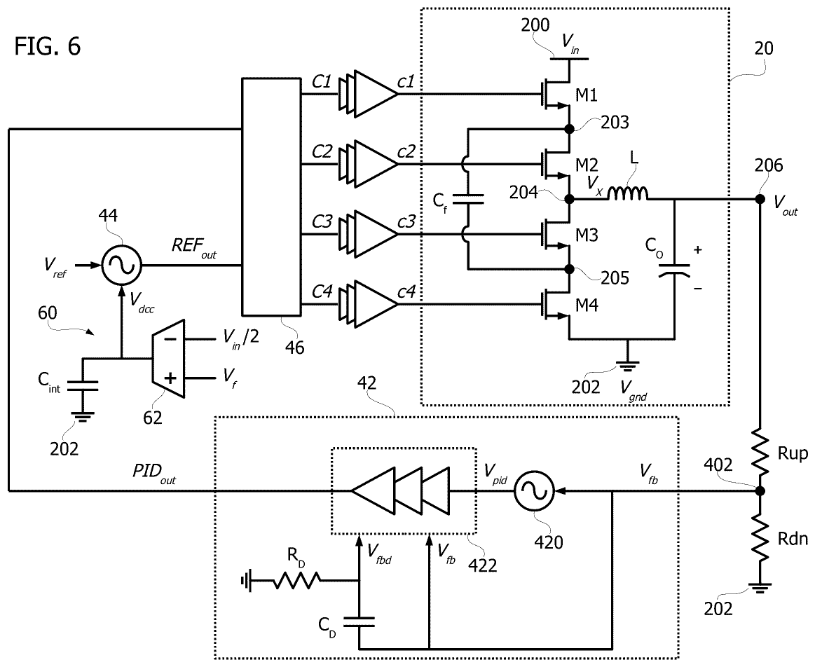

One or more embodiments relate to improvements of the control circuitry of converter 20 that facilitate balancing the voltage across capacitor C_{f}. FIG. 6 is a circuit block diagram exemplary of a three-level hybrid buck converter including such improved time-based control circuitry.

In particular, as exemplified in FIG. 6, one or more embodiments rely on the time-based control circuitry disclosed with reference to FIG. 4 (that is, including time-based PID controller 42, reference voltage-controlled oscillator 44 and phase detector 46) to regulate the output voltage Vₒᵤₜ. Additionally, the control circuitry includes a flying capacitor voltage balancing circuit 60 configured to sense the flying capacitor voltage V_{f} and the input voltage Vᵢₙ, and produce a duty-cycle control signal V_{dec} indicative of the difference between the actual flying capacitor voltage V_{f} and the target flying capacitor voltage, which is equal to half of the input voltage Vᵢₙ (i.e., Vᵢₙ/2). For instance, the balancing circuit 60 may comprise a transconductance amplifier circuit 62 having a first (e.g., non-inverting) input configured to receive the flying capacitor voltage V_{f} and a second (e.g., inverting) input configured to receive a target voltage (e.g., voltage Vᵢₙ/2 which may be produced starting from voltage Vᵢₙ, e.g., via a voltage divider circuit not visible in the Figures annexed herein). The transconductance amplifier circuit 62 may thus produce an output current as a function of (e.g., proportional to) the difference between V_{f} and the target voltage (e.g., Vᵢₙ/2). The balancing circuit 60 may further comprise a capacitor Cᵢₙₜ coupled between the output of amplifier 62 and ground 202, thus configured to be charged and discharged by the output current of amplifier 62. By this arrangement, a voltage duty-cycle control signal V_{dec} is produced across capacitor Cᵢₙₜ which is indicative of (e.g., proportional to) the difference between V_{f} and the target voltage (e.g., Vᵢₙ/2). The reference voltage-controlled oscillator 44 is configured to receive the duty-cycle control signal V_{dcc} and adjust the duty-cycle of the reference clock signal REFₒᵤₜ accordingly. For instance, signal V_{dec} may be used to control an amount of advance or an amount of delay of the falling edges of the clock signal REFₒᵤₜ with respect to a 50% duty-cycle clock signal. By doing so, it is possible to introduce an imbalance between the flying capacitor charge phase (e.g., phase ϕ1) and the flying capacitor discharge phase (e.g., phase ø3).

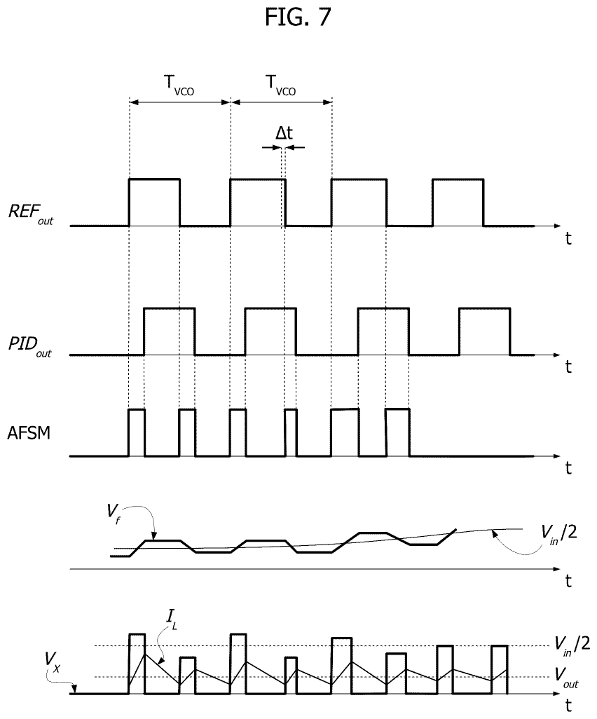

Operation of the improved control circuitry of converter 20 may be further understood with reference to FIG. 7, which is a time diagram exemplary of possible time evolution of signals REFₒᵤₜ, PIDₒᵤₜ, V_{f}, Vᵢₙ/2, V_{X}, I_{L} (i.e., the inductor current) and Vₒᵤₜ in the converter of FIG. 6, where the phase detector 46 is assumed to operate as disclosed with reference to FIG. 5. With reference to FIG. 7, we can assume that the reference voltage-controlled oscillator 44 and the feedback voltage-controlled oscillator 420 operate at a nominal (e.g., steady-state) duty-cycle equal to 50%. As previously discussed, the output voltage Vₒᵤₜ is regulated by the phase detector (e.g., finite state machine) 46 using both the rising and the falling edges of the clock signals coming from the reference path (i.e., REFₒᵤₜ) and from the feedback path (i.e., PIDₒᵤₜ), or using their levels. At steady-state, two symmetrical control phases are produced (ϕ1 and ϕ3), and the voltage V_{X} at the switching node 204 is switched between (Vᵢₙ−V_{f}) and V_{f}. If V_{f} is not equal to the target voltage (e.g., Vᵢₙ/2), the duty-cycle of clock signal REFₒᵤₜ produced by the reference voltage-controlled oscillator 44 is changed (see, e.g., the duty-cycle being increased by a quantity Δt at the second falling edge of signal REFₒᵤₜ in FIG. 7, thereby reducing the duration of the third operation phase of converter 20) to produce an imbalance between the first control phase and the third control phase, thereby balancing the flying capacitor voltage V_{f}. In this way, the charge phase and the discharge phase of capacitor C_{f} are not symmetrical anymore, and the voltage V_{f} across capacitor C_{f} changes. In the meanwhile, the main control loop of converter 20 operates to keep the output voltage Vₒᵤₜ equal to the reference voltage V_{ref}. Once the voltage V_{f} across capacitor C_{f} is again equal to the target voltage (e.g., Vᵢₙ/2), the duty-cycle of the reference clock signal REFₒᵤₜ returns to its steady-state value (e.g., 50%).

By resorting to the operation discussed above, the power switches M1, M2, M3, M4 may be protected from sustaining a voltage that could be much higher than Vᵢₙ/2, which could occur both at startup and during line/load transient in a three-level converter as exemplified herein, also at steady-state due to the presence of parasitic capacitor which could create an unbalance on the flying capacitor voltage.

It will be noted that one or more embodiments have been disclosed herein (e.g., with reference to FIG. 6) where the duty-cycle control signal V_{dcc} is received by the reference voltage-controlled oscillator 44 to produce an imbalance between the flying capacitor charge and discharge phases and thereby balancing the flying capacitor voltage. Additionally or alternatively, in one or more embodiments, the duty-cycle control signal V_{dcc} may be received by the feedback voltage-controlled oscillator 420 in order to produce the same effect by adjusting the duty-cycle of the first (delayed) clock signal PIDₒᵤₜ. For instance, signal V_{dec} may be used to control an amount of advance or an amount of delay of the falling edges of signal PIDₒᵤₜ with respect to a 50% duty-cycle clock signal.

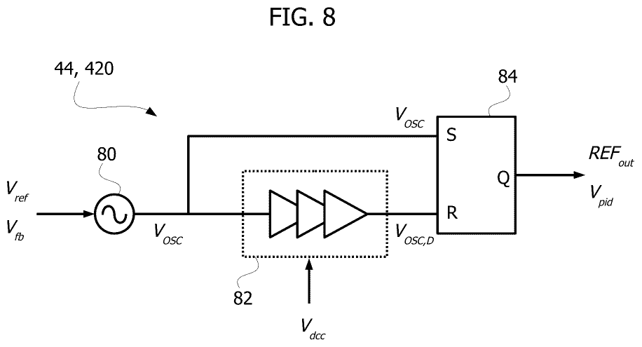

FIG. 8 is a circuit block diagram exemplary of a possible implementation of a voltage-controlled oscillator 44 or 420 as may be provided in one or more embodiments, configured to receive the duty-cycle control signal V_{dec} and adjust the duty-cycle of the output clock signal (REFₒᵤₜ or V_{pid}) accordingly. As exemplified in FIG. 8, a voltage-controlled oscillator 80 receives a reference voltage (e.g., voltage V_{ref} in the case of oscillator 44, or voltage V_{fb} in the case of oscillator 420) and produces an oscillating signal V_{OSC} having a frequency as a function of the reference voltage. A voltage-controlled or current-controlled delay line 82 receives the oscillating signal V_{OSC} and the duty-cycle control signal V_{dcc}, and produces a delayed oscillating signal V_{OSC,D} whose amount of delay is a function of the value of signal V_{dcc}. A logic circuit is configured to assert an output signal in response to an edge being detected in the oscillating signal V_{OSC}, and de-assert the output signal in response to a corresponding edge being detected in the delayed oscillating signal V_{OSC,D}. For instance, a set-reset (SR) flip-flop circuit 84 receives the oscillating signal V_{OSC} at a respective SET(S) input terminal and the delayed oscillating signal V_{OSC,D} at a respective RESET (R) input terminal. The output (Q) of flip-flop 84 is asserted (e.g., set to ‘1’) in response to the rising edges of the oscillating signal V_{OSC}, and it is de-asserted (e.g., reset to ‘0’) in response to the rising edges of the delayed oscillating signal V_{OSC,D}, so that the duty-cycle of the output signal (REFₒᵤₜ or V_{pid}) is adjusted as a function of the value of signal V_{dcc}.

The controller topology disclosed herein may be used for any three-level-like based converter topology (like the ones described, for instance, in document [5]) or hybrid switched capacitor converter topology which relies on a 4-phase control algorithm.

Advantageously, a flying capacitor voltage balance control circuit as exemplified herein can also facilitate reducing the startup time of the converter without relying on pre-charge or dedicated startup circuitry.

One or more embodiments may be applied, for instance, in battery charger integrated circuits, power management integrated circuits (PMIC) (e.g., for use in wearable devices), USB-powered embedded applications, envelope tracking in radio frequency (RF) applications, and the like.

One or more embodiments may thus provide one or more of the following advantages:
achieving high output voltage accuracy exploiting the benefit of time-based control;
reducing the power consumption and the overall system complexity while maintaining good performance, insofar as high-resolution components such as PWM, ADCs, DACs are not required by one or more embodiments;
small system impact/effort with respect to previous converter systems, insofar as some of the components used to regulate the voltage on the flying capacitor are already present in the control loop of the converter (e.g., the voltage-controlled oscillators 420 and 44) and only a duty-cycle control is introduced; and
possibility of implementing the control circuitry according to one or more embodiments both for single-ended and for differential signals without significant changes in the area occupation of the controller.

Without prejudice to the underlying principles, the details and embodiments may vary, even significantly, with respect to what has been described by way of example only, without departing from the extent of protection.

The extent of protection is determined by the annexed claims.

### LIST OF REFERENCE DOCUMENTS

[1] S. J. Kim, Q. Khan, M. Talegaonkar, A. Elshazly, A. Rao, N. Grissett, G. Winter, W. McIntyre, and P. K. Hanumolu, “High Frequency Buck Converter Design Using Time-Based Control Techniques,” in IEEE Journal of Solid-State Circuits, vol. 50, no. 4, pp. 990-11 Apr. 2015, doi: 10.1109/JSSC.2014.2378216.
[2] S. J. Kim, R. K. Nandwana, Q. Khan, R. C. N. Pilawa-Podgurski, and P. K. Hanumolu, “A 4-Phase 30-70 MHz Switching Frequency Buck Converter Using a Time-Based Compensator,” in IEEE Journal of Solid-State Circuits, vol. 50, no. 12, pp. 2814-2824 December 2015, doi: 10.1109/JSSC.2015.2456884.
[3] S. J. Kim, W. Choi, R. Pilawa-Podgurski, and P. K. Hanumolu, “A 10 MHz 2-800 mA 0.5-1.5 V 90% Peak Efficiency Time-Based Buck Converter With Seamless Transition Between PWM/PFM Modes,” in IEEE Journal of Solid-State Circuits, vol. 53, no. 3, pp. 814-824, March 2018, doi: 10.1109/JSSC.2017.2776298.
[4] X. Liu, P. K. T. Mok, J. Jiang and W.-H. Ki, “Analysis and Design Considerations of Integrated 3-Level Buck Converters,” in IEEE Transactions on Circuits and Systems I: Regular Papers, vol. 63, no. 5, pp. 671-682, May 2016, doi: 10.1109/TCSI.2016.2556098.

[5] Z. Xia and J. Stauth, “A Two-Stage Cascaded Hybrid Switched-Capacitor DC-DC Converter with 96.9% Peak Efficiency Tolerating 0.6 V/μs Input Slew Rate During Startup,” 2021 IEEE International Solid-State Circuits Conference (ISSCC), 2021, pp. 256-258, doi: 10.1109/ISSCC42613.2021.9365763.

1. A control circuit for a DC-DC converter, comprising:
a feedback circuit configured to generate a feedback voltage dependent on an output voltage of the DC-DC converter;
a first voltage controlled oscillator configured to generate a first clock signal having a frequency dependent on the feedback voltage;
a first programmable delay line configured to delay the first clock signal and output a second clock signal with a delay relative to the first clock signal set as a function of the feedback voltage and a derivative of the feedback voltage; and
a phase detector circuit configured to generate pulse width modulation control signals for controlling switching operation of the DC-DC converter, said pulse width modulation control signals generated in response to a detected a phase difference between the second clock signal and a third clock signal.

2. The control circuit of claim 1, further comprising a resistor-capacitor filter circuit configured to generate the derivative of the feedback voltage from the feedback voltage.

3. The control circuit of claim 1, further comprising a second voltage controlled oscillator configured to generate the third clock signal having a frequency dependent on a reference voltage.

4. The control circuit of claim 3, wherein the third clock signal has a duty cycle and further comprising a duty cycle adjustment circuit configured to adjust the duty cycle of the third clock signal.

5. The control circuit of claim 4, wherein the duty cycle adjustment circuit includes a differential amplifier circuit having a first input configured to receive a reference voltage and a second input configured to receive a flyback capacitor voltage, the differential amplifier circuit configured to generate a duty cycle control signal for application to the second voltage controlled oscillator, said duty cycle control signal comprising a difference between the reference voltage and the flyback capacitor voltage.

6. The control circuit of claim 5, further comprising a capacitor coupled to an output of the differential amplifier circuit to store a voltage of the duty cycle control signal.

7. The control circuit of claim 5, wherein the DC-DC converter is a three-level hybrid buck converter have a flyback capacitor connected across first and second switching transistors, and where the flyback capacitor voltage is a voltage across the flyback capacitor.

8. The control circuit of claim 1, further comprising:
a second voltage controlled oscillator configured to generate a fourth clock signal having a frequency dependent on a reference voltage;
a programmable delay line configured to delay the fourth clock signal and output a fifth clock signal with a delay relative to the fourth clock signal that is dependent on a duty cycle control signal;
a flip-flop circuit having a data input configured to receive the fourth clock signal and a clock input configured to receive the fifth clock signal, wherein an output of the flip-flop circuit generates the third clock signal with a duty cycle adjusted in response to the duty cycle control signal.

9. The control circuit of claim 8, further comprising a differential amplifier circuit having a first input configured to receive a reference voltage and a second input configured to receive a flyback capacitor voltage, the differential amplifier circuit configured to generate a duty cycle control signal for application to the second voltage controlled oscillator, said duty cycle control signal comprising a difference between the reference voltage and the flyback capacitor voltage.

10. The control circuit of claim 9, further comprising a capacitor coupled to an output of the differential amplifier circuit to store a voltage of the duty cycle control signal.

11. The control circuit of claim 9, wherein the DC-DC converter is a three-level hybrid buck converter have a flyback capacitor connected across first and second switching transistors, and where the flyback capacitor voltage is a voltage across the flyback capacitor.

12. A control circuit for a DC-DC converter, comprising:
a feedback circuit configured to generate a feedback voltage dependent on an output voltage of the DC-DC converter;
a first voltage controlled oscillator configured to generate a first clock signal having a frequency dependent on the feedback voltage;
a first programmable delay line configured to delay the first clock signal and output a second clock signal with a delay relative to the first clock signal set as a function of a duty cycle control signal;
a flip-flop circuit having a data input configured to receive the first clock signal and a clock input configured to receive the second clock signal, wherein an output of the flip-flop circuit generates a third clock signal with a duty cycle adjusted in response to the duty cycle control signal; and
a phase detector circuit configured to generate pulse width modulation control signals for controlling switching operation of the DC-DC converter, said pulse width modulation control signals generated in response to a detected a phase difference between the third clock signal and a fourth clock signal.

13. The control circuit of claim 12, further comprising a second voltage controlled oscillator configured to generate the fourth clock signal having a frequency dependent on a reference voltage.

14. The control circuit of claim 13, wherein the fourth clock signal has a duty cycle and further comprising a duty cycle adjustment circuit configured to adjust the duty cycle of the fourth clock signal.

15. The control circuit of claim 12, further comprising a differential amplifier circuit having a first input configured to receive a reference voltage and a second input configured to receive a flyback capacitor voltage, the differential amplifier circuit configured to generate the duty cycle control signal in response to a difference between the reference voltage and the flyback capacitor voltage.

16. The control circuit of claim 15, further comprising a capacitor coupled to an output of the differential amplifier circuit to store a voltage of the duty cycle control signal.

17. The control circuit of claim 15, wherein the DC-DC converter is a three-level hybrid buck converter have a flyback capacitor connected across first and second switching transistors, and where the flyback capacitor voltage is a voltage across the flyback capacitor.
